(19) United States
(12) Patent Application Publication
(10) Pub. No.: US 2013/0025467 A1
(43) Pub. Date: Jan. 31, 2013

(54) HOT TEA DISPENSER

(71) Applicants: A.A. Jud Schroeder, San Antonio, TX (US); Jason Minica, Schertz, TX (US); David Santy, Converse, TX (US)

(72) Inventors: A.A. Jud Schroeder, San Antonio, TX (US); Jason Minica, Schertz, TX (US); David Santy, Converse, TX (US)

(73) Assignee: Schroeder Industries, Inc. d/b/a Schroeder America, San Antonio, TX (US)

(21) Appl. No.: 13/554,654

(22) Filed: Jul. 20, 2012

Related U.S. Application Data
(60) Provisional application No. 61/511,300, filed on Jul. 25, 2011.

(51) Int. Cl. A47J 31/46

(52) U.S. Cl. 99/323.3

(57) ABSTRACT

Applicants provide a post-mix hot tea dispenser which foregoes the use of electrical elements in the flow control circuits. Applicants provide a dispenser with a manually operated T-valve mounted to the front of a housing. The housing contains mechanical (non-electrical) flow control elements to provide a measured flow of a concentrate and a diluent in the proper proportion to the post-mix valve.

This is a utility patent application that claims benefit of, priority to, and incorporates by reference U.S. Provisional Patent Application Ser. No. 61/511,300, filed Jul. 25, 2011.

### FIELD OF THE INVENTION

Beverage dispensers and, more specifically, a dispenser providing for the controlled ratio post-mixing of a concentrate with hot water in a manually operated mixing and dispensing valve.

### BACKGROUND OF THE INVENTION

This application incorporates by reference U.S. patent application Ser. No. 12/944,457, filed Nov. 11, 2010, entitled A Post-Mix Dispenser Assembly.

Present post-mix dispensing devices prepare a beverage from the mixing of a concentrate, such as syrup and a diluent, such as water, for dispensing into a container. The diluent may be water and the concentrate may be a tea beverage concentrate, such as found in a “bag and a box.”

Some prior art post-mix hot tea devices provide for mixing upstream of the nozzle and for the electronic control of the concentrate and diluent fluid flow circuits, such as through the use of solenoids and the like. There are certain advantages and disadvantages to such mixing, including the need for periodically cleansing the mixing chamber and elements downstream thereof. Electronic control of the product flow is typical in prior hot beverage dispensers.

### SUMMARY OF THE INVENTIONS

Applicants provide a post-mix hot tea beverage dispenser which forgoes the use of electrical elements in the flow control circuits therein. Specifically, Applicants provide for hot tea dispensing in a dispenser that forgoes the use of a transformer, solenoid control, and other electronic elements. More specifically, Applicants provide flow control through the use of a mechanical (non-electrical) concentrate flow control circuit and a diluent or water flow control circuit. The flow control circuits are controlled by elements, such as flow control valves, including the flow control valve disclosed in U.S. patent application Ser. No. 12/465,283, filed May 13, 2009, entitled “Flow Control and Manifold Assembly,” which is incorporated herein by reference, and available from Schroeder America, San Antonio, Tex., as “Flow control assembly and manifold” (in various forms).

Applicants also provide for a hot beverage dispensing device that is post-mix with a manually operated T-valve, which provides for post-mixing the beverage in a nozzle thereon. That is to say, the beverage, comprising the concentrate and diluent (typically hot water and tea concentrate) will mix effectively in the nozzle of the T-valve, thus simplifying cleanup. Cleanup will typically only comprise the toolless removal of elements, such as the housing of the nozzle of the T-valve assembly without the need for disassembly. A T-valve is seen in FIGS. 2 and 3 having a longitudinal axis, handle on top, nozzle on the bottom, with fluid lines coming from the horizontal member between the handle and nozzle.

Applicants also provide a hot beverage dispenser comprising a pressurized diluent source, a heating tank for receipt and heating of a pressurized diluent from the diluent source, a heating control circuit for controlled heating of the diluent in the heating tank, a pressurized concentrate source, a manually operated dispensing nozzle having a housing, the housing for receipt of a pressurized heated diluent thereon and a pressurized concentrate thereon and adapted to mix the diluent and concentrate on the walls thereon and for dispensing the mixture into a container, a first adjustable mechanical flow control valve between the pressurized diluent source and the heating tank, and a second adjustable flow control valve between the pressurized concentrate source and the nozzle.

### BRIEF DESCRIPTION OF THE DRAWINGS

FIG. 1 is an illustration of Applicants' Hot Tea Dispenser.

FIGS. 2 and 3 are adapted from FIGS. 12B and 12C of '457 patent application.

### DETAILED DESCRIPTION OF THE PREFERRED EMBODIMENTS

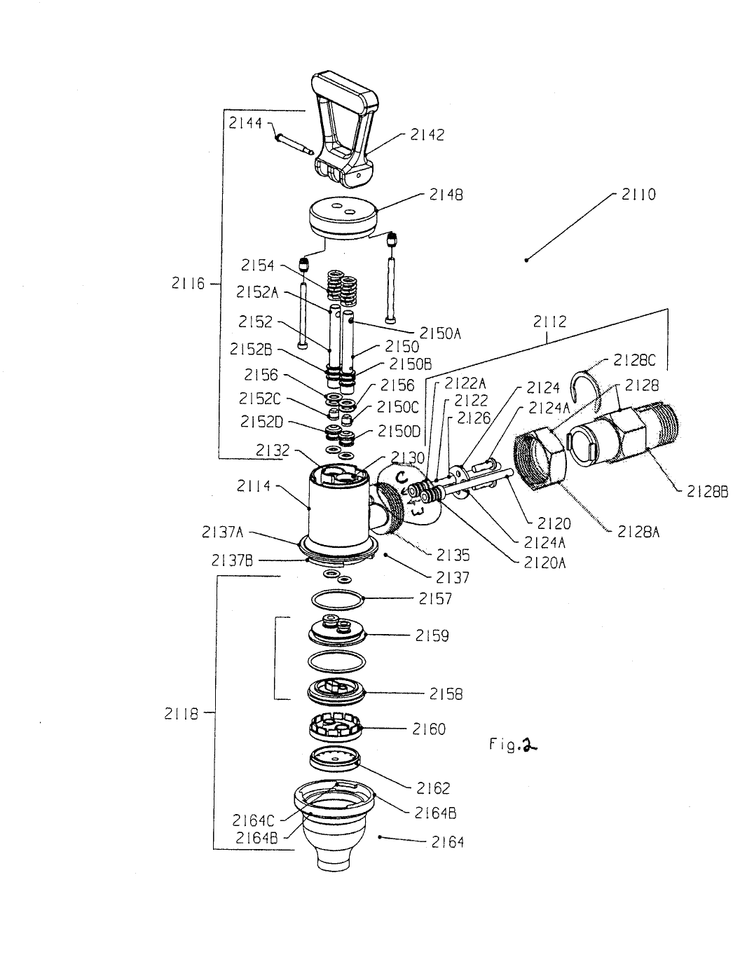

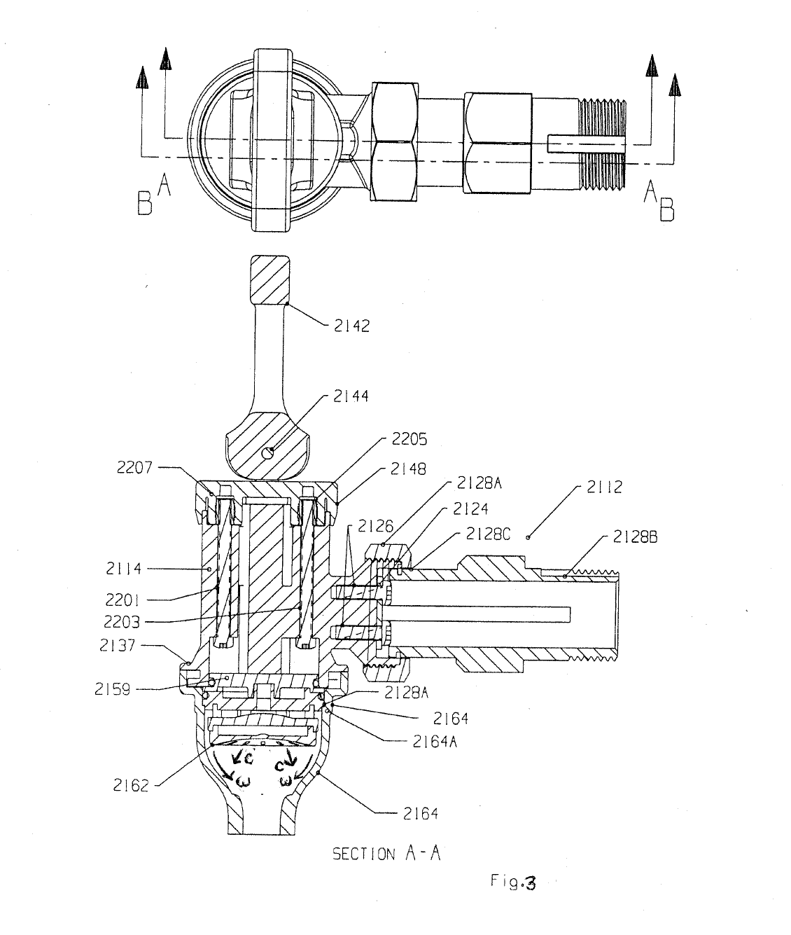

The hot tea dispenser 10 comprises an urn housing 11 that contains within it some of the elements thereof and others are typically located outside the urn. Urn housing may be opaque as, for example, made from a suitable metal, and include an interior volume of between about 0.5 and 1.5 cubic meters. Applicants' hot tea dispenser 10 can be seen to be comprised of a concentrate flow circuit 12 and a water flow control circuit 14. The concentrate flow circuit 12 will typically carry a highly concentrated beverage, such as tea concentrate. The water flow circuit 14 carries a diluent, such as water, therethrough. The diluent (water) and concentrate typically meet in the nozzle 21 of a post-mixing and dispensing valve 16, such as that disclosed in pending U.S. patent applications Ser. Nos. 12/944,457 and 12/286,441, both of which are incorporated herein by reference, and as seen in FIGS. 2 and 3.

The concentrate flow control circuit 12 may include a bag in box source of concentrate 13 (within or without housing 11), which is typically pressurized by pump 19 (which may be electrical or powered by compressed gas) and typically includes a non-electrical concentrate flow control valve or flow control mechanism 15 for receiving pressurized fluid concentrate from pump 19 and the “bag in box” or other source. Downstream of the concentrate flow control 15, under controlled output pressure the concentrate is supplied to the mixing and dispensing valve 16, typically on the inner wall of the housing of the nozzle thereof. Typically, no electrical components comprise concentrate flow control circuit 12, as pump 19 may be driven by compressed gas, although optionally an electric pump may be provided.

The diluent or water flow control circuit 14 may include a pressurized water supply 18, such as municipal water, engaged to a non-electrical water flow control mechanism or valve 20, typically similar to concentrate flow control valve or mechanism 15. Downstream of flow control mechanism or valve 20 is a tank 22 to receive the pressurized water, typically, for example, at pressures of about 80 to 100, about max 125 psi. Typically, flow controls 15/20 are adjustable to set the flow rate of the fluids therethrough to provide proportion of mix between concentrate and water. Typically, a 5:1 ratio (diluent/concentrate) may be used. Preferably, the flow controls 15/20 are self-adjusting to compensate for changes in pressure upstream thereof. Downstream of tank 22 is mixing and dispensing post-mix valve 26 where hot water is supplied, typically to the inner wall of the housing 2164 of the nozzle (see FIG. 2) upstream of where the concentrate is applied to the inner wall of the housing.

Tank 22 may have an elongated vertical dimension and typically is located within the walls of urn housing 11. Urn housing 11 typically has an elongated vertical dimension also. Tank 22 may have tank side walls 22a, tank top wall 22b, and tank bottom wall 22c. Tank 22 may be in any number of configurations, including cylindrical or rectangular and may have a volume of about 24 ounces or other suitable volume (range about 12-36). Tank 22 is seen to have tank inlet 24 for receiving pressurized water at ambient temperature from flow control 20. Tank inlet 24 is seen to be at or near the top wall 22b. Further, in a preferred embodiment, tank inlet 24 is at or near the top wall 22b. When so located, a fluid tube 25 may be provided for delivering water at ambient temperature down to a point where it will mix with the contents of the tank at tube removed end 25a. Tank 22 is further seen to have a tank outlet 26, which may be in or near top wall 22b. A pressure relief valve 28, set to a pressure above about city water pressure plus thermal expansion (typically about 10-20% more), but lower than handle popoff pressure may be provided typically on top wall 22b and will provide relief for an over temperature condition or an over pressure condition. An arrester may be used upstream of tank inlet 24 to help control pressure increase upstream of the tank from thermal expansion.

Water, heated and under pressure from upstream source, such as pressurized water supply 18, and under a set flow control rate, as set forth in more detail below, exits from or near the top of tank 22 out the tank outlet 26, and is delivered to mix and dispensing valve 16. Handle 17, manually operated by the user, will allow for the delivery of the controlled flow of hot water and the controlled flow of concentrate to the nozzle 21 of manual valve 17. The flow control of the water is seen to have no electronic elements.

A power control circuit 30 as known in the art may be provided whose function is to provide heat energy to the contents of pressurized tank 22 in a controlled manner, such that the water temperature is sufficient, when mixed with the concentrate at ambient temperature and dispensed from nozzle 21, to provide a drink with a temperature between about 120-160° F.

Power control circuit 30 may include heating element 32, such as a 1450 watt heating element, provided with energy from an output on a power control board 31. Heating element is located within tank 22. The power control board (PCB) 31 may be energized from a power cord 40 receiving external AC power and optionally, connected through an ICE connector 41 to the power control board 31. An adjustable thermostat 33 on PCB 31 may provide the user with the ability to control the upper temperature of the mix at nozzle 21, through the control of the temperature of the water in tank 22.

Temperature sensor 38 may be provided on the outer surface of or inside of tank 22 for engagement with the power control board and for controlling the energization of heater element 32. That is to say, electrical energy to heater element 32 can be controlled through PCB 31, in part, by the receipt of temperature readings at temperature sensor 38. A circuit for controlling high temperature overload may be provided and overload circuit 34, which may include the high load fuse 36.

LEDs 42 (red) and 44 (green) may provide visual indicia on the front wall of the urn, typically adjacent or just above mixing/dispensing valve 16. LEDs 42/44 operate off the PCB 31 and responsive to temperature sensor 38 typically indicate a ready (green) condition when the temperature of the tank is sufficient to ensure a hot beverage dispenser (for example, range of 120-160° F.). Red typically indicates a temperature below or above a preselected valve set.

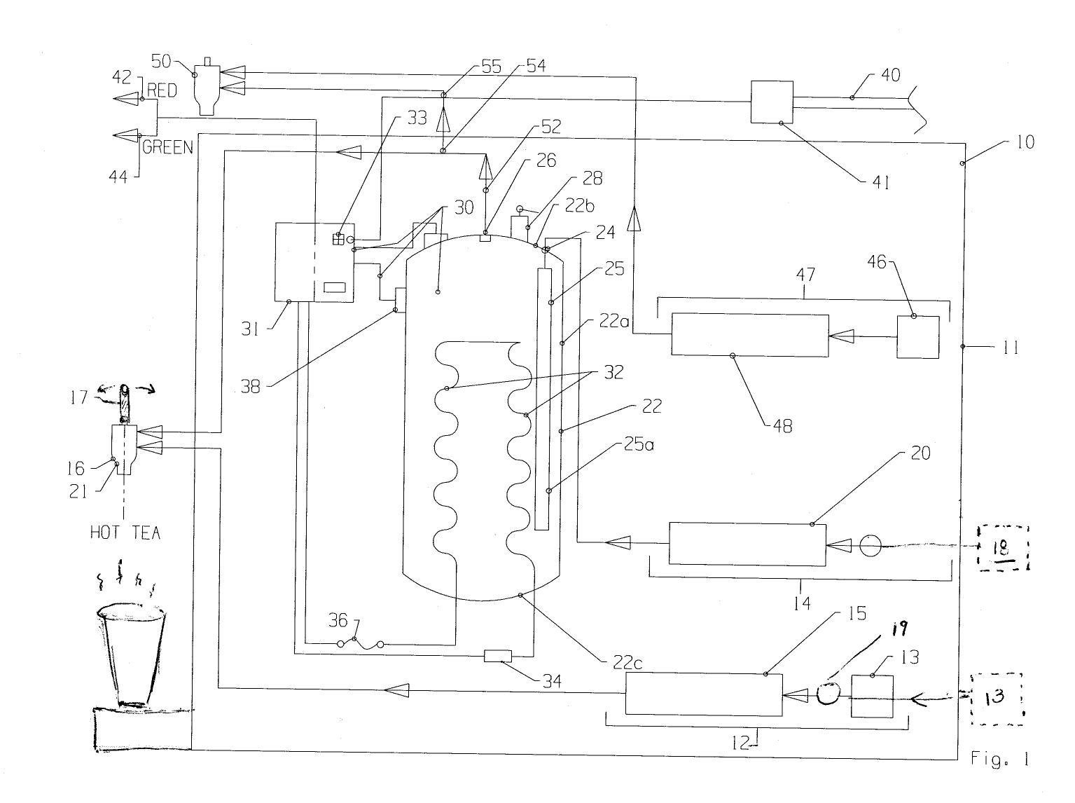

FIG. 1 illustrates flow controls 15/20 inside the urn housing. In another embodiment, they may be outside the urn housing. A second concentrate flow control circuit 47 may be provided, for a second manually operated post mix valve 50. This second circuit typically includes a second bag in box or other concentrate 46 and a second concentrate flow control device 48. A junction, such as a T-junction 54, may be provided in the outlet line 52 between tank 22 and manual post mix valve 17. Optionally, a second T-valve valve 50 is provided adjacent valve 17, for receiving concentrate and hot water as illustrated from branch line 55.

FIGS. 2 and 3 comprise FIGS. 12B and 12C, respectively, of the '457 patent application and are included here, without the recitation of the description. However, they are included here with the C and W letter notations thereon showing concentrate C and water W entering the valve through connections 2122a/2120a (see FIG. 2). In FIG. 3, and as explained in more detail in the '457 reference incorporated herein, the arrows in the cross-sectional view of the nozzle show the concentrate C and the water W mixing on the inside of the nozzle. Moreover, this is the only point in Applicants' nozzle where the water and concentrate mix. Further, the nozzle is easily removed without tools for cleaning.

Although the invention has been described in connection with the preferred embodiment, it is not intended to limit the invention's particular form set forth, but on the contrary, it is intended to cover such alterations, modifications, and equivalences that may be included in the spirit and scope of the invention as defined by the appended claims.

1. A hot beverage dispenser comprising:
a pressurized diluent source;
a heating tank for receipt and heating of a pressurized diluent from the diluent source;
a heating control circuit for controlled heating of the diluent in the heating tank;
a pressurized concentrate source;
a manual handle operated post-mix dispensing valve having a handle, a valve body, an inlet member adapted to carry a diluent and a concentrate, and a nozzle, the body for receipt of a pressurized heated diluent therein and a pressurized concentrate therein and the nozzle adapted to mix the diluent and concentrate on the walls thereon and for dispensing the mixture into a container;
a first mechanical flow control valve between the pressurized diluent source and the heating tank; and
a second mechanical flow control valve between the pressurized concentrate source and the nozzle.

2. The hot beverage dispenser of claim 1, wherein the pressurized diluent source is city water.

3. The hot beverage dispenser of claim 1, wherein the pressurized concentrate source comprises a bag-in-box syrup and a pump upstream of the second adjustable mechanical flow control valve.

4. The hot beverage dispenser of claim 1, further including a housing for substantially enclosing the heating tank, heating control circuit, pressurized concentrate source, the first mechanical flow control valve and the second mechanical flow control valve therein with the manual handle operated dispensing valve being mounted by the inlet member to a side wall of the housing.

5. The hot beverage dispenser of claim 1, wherein the heating tank has a capacity of between about 12 and about 36 ounces.

6. The hot beverage dispenser of claim 1, wherein the nozzle of the manual handle operated dispensing valve is removably attached to the body of the valve.

7. The hot beverage dispenser of claim 1, wherein the pressurized concentrate source includes tea syrup.

8. The hot beverage dispenser of claim 1, wherein the pressurized diluent source is city water; and wherein the pressurized concentrate source comprises a bag-in-box syrup and a pump upstream of the second adjustable mechanical flow control valve.

9. The hot beverage dispenser of claim 1, wherein the first adjustable mechanical flow control valve and the second adjustable mechanical flow control valve are self-adjusting.

10. The hot beverage dispenser of claim 1, further including a tea ready signal circuit adapted to visually indicate a temperature condition indicating a ready condition for dispensing.

11. The hot beverage dispenser of claim 1, wherein the mechanical flow control valves are manually adjustable.

12. The hot beverage dispenser of claim 1, wherein the post-mix dispensing valve is a T-valve.

13. A hot beverage dispenser comprising:
a pressurized diluent source;
a heating tank for receipt and heating of a pressurized diluent from the diluent source;
a heating control circuit for controlled heating of the diluent in the heating tank;
a pressurized concentrate source;
a manual, handle operated post-mix dispensing valve having a handle, a valve body, an inlet member adapted to carry a diluent and a concentrate, and a nozzle, the body for receipt of a pressurized heated diluent therein and a pressurized concentrate therein, the nozzle adapted to mix the diluent and concentrate on the walls thereon, for dispensing the mixture into a container;
a first mechanical flow control valve between the pressurized diluent source and the heating tank; and
a second mechanical flow control valve between the pressurized concentrate source and the nozzle;
wherein the pressurized diluent source is city water;
wherein the pressurized concentrate source comprises a bag-in-box syrup and a pump upstream of the second adjustable mechanical flow control valve;
further including a housing for substantially enclosing the heating tank, heating control circuit, the first mechanical flow control valve and the second mechanical flow control valve therein with the manual handle operated dispensing T-valve being mounted by the inlet member to a side wall of the housing;
wherein the heating tank has a capacity of between 12 and 36 ounces;
wherein the nozzle of the manual handle operated dispensing valve is removably attached to the body of the valve;
wherein the pressurized concentrate source includes tea syrup; and further including a tea ready signal circuit adapted to visually indicate a temperature condition indicating a ready condition for dispensing.
